(19) United States
(12) Patent Application Publication
(10) Pub. No.: US 2008/0035280 A1
(43) Pub. Date: Feb. 14, 2008

(54) ADJUSTING STRUCTURE OF A CURTAIN FOR ADJUSTING THE ANGLE OF CURTAIN BLADE

(76) Inventor: Ke-Min Lin, Chiayi City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/463,503

(22) Filed: Aug. 9, 2006

(51) Int. Cl. E06B 9/307

(52) U.S. Cl. 160/176.1 R

(57) ABSTRACT

An adjustable structure of a curtain for adjusting the angle of curtain blade comprises a winding tube disposed in an upper rail of a curtain, a pulling string for controlling the rise and fall of the curtain winds around the winding tube and is then passed through curtain blades. One end of the winding tube is disposed with a rubbing wheel for hanging the top end of a suspending string that is provided for insertion of the curtain blades. Thereby during the rise and fall of the curtain blades, the suspending string is pulled towards the rotating direction of the winding tube firstly, so that the angle of the curtain blades is adjusted.

### BACKGROUND OF THE INVENTION

1. Field of the Invention

The present invention relates to an adjustable structure of a curtain for adjusting the angle of curtain blade comprises a winding tube disposed in an upper rail of a curtain, a pulling string for controlling the rise and fall of the curtain winds around the winding tube and is then passed through curtain blades. One end of the winding tube is disposed with a rubbing wheel for hanging the top end of a suspending string that is provided for insertion of the curtain blades. Thereby during the rise and fall of the curtain blades, the suspending string is pulled to be skewed towards the rotating direction of the winding tube firstly, so that the angle of the curtain blades is adjusted.

2. Description of the Prior Art

Most conventional curtains are used to shield the sunlight, so in addition to a structure of controlling the rise and fall of the curtain, the curtain must have a function of adjusting the angle of the curtain blades, so as to adjust the indoor sunlight.

Therefore, the conventional curtain mainly includes two structures: one structure is to control the rise and fall, and the other structure is to adjust the angle of the curtain blades. After the curtain blades are adjusted to a suitable position, the angle of the blades can be controlled by the control structure, at this moment, the density of the sunlight projected into the room can be adjusted, thus attaining the purposes of shielding and lighting. However, since those two structures are designed and produced separately, the conventional curtain is difficult to assemble and is high cost.

The present invention has arisen to mitigate and/or obviate the afore-described disadvantages.

### SUMMARY OF THE INVENTION

The primary objective of the present invention is to provide an adjustable structure of a curtain for adjusting the angle of curtain blade comprises a winding tube disposed in an upper rail of a curtain, a pulling string for controlling the rise and fall of the curtain winds around the winding tube and is then passed through curtain blades. One end of the winding tube is disposed with a rubbing wheel for hanging the top end of a suspending string that is provided for insertion of the curtain blades, thereby the suspending string will be affected by the rubbing wheel. To summarize, the present invention has the following functions:

Firstly, since the top end of the suspending string is hanged on the winding tube that is provided for winding the pulling string, when the pulling string is regained or struck, the winding tube will be rotated. During the rotation of the winding tube, the angle of the suspending string is changed (when the blades are risen and fallen slightly, the angles between the blades are changed, and there will appear a dead point after being brought into contact with each other), so that the curtain blades will be maintained in a skewed position during the rise and fall of the curtain. After the curtain blades are being adjusted to a predetermined position, the user slightly reverse the curtain blades until the angle of the blades is meet the needs of the user.

Secondly, the winding tube and the rubbing wheel are disposed in the upper rail, which is easy to operate, low cost, and has a nice appearance.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of an adjustable structure of a curtain for adjusting the angle of curtain blade in accordance with the present invention;

FIG. 2 is a structural view of a roller in accordance with the present invention;

FIG. 3 is another perspective view of the adjustable structure of a curtain for adjusting the angle of curtain blade in accordance with the present invention;

FIG. 4 is an operational view of the adjustable structure of a curtain for adjusting the angle of curtain blade in accordance with the present invention;

FIG. 5 is another operational view of the adjustable structure of a curtain for adjusting the angle of curtain blade in accordance with the present invention;

FIG. 6 is a further perspective view of showing the rotation of the curtain blades; and

FIG. 7 is a cross sectional view of the adjustable structure of a curtain for adjusting the angle of curtain blade in accordance with the present invention.

### DETAILED DESCRIPTION OF THE PREFERRED EMBODIMENTS

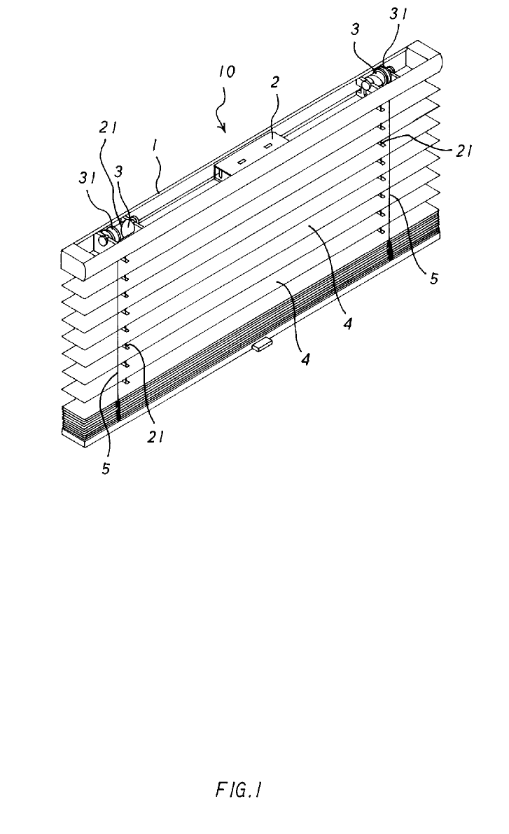

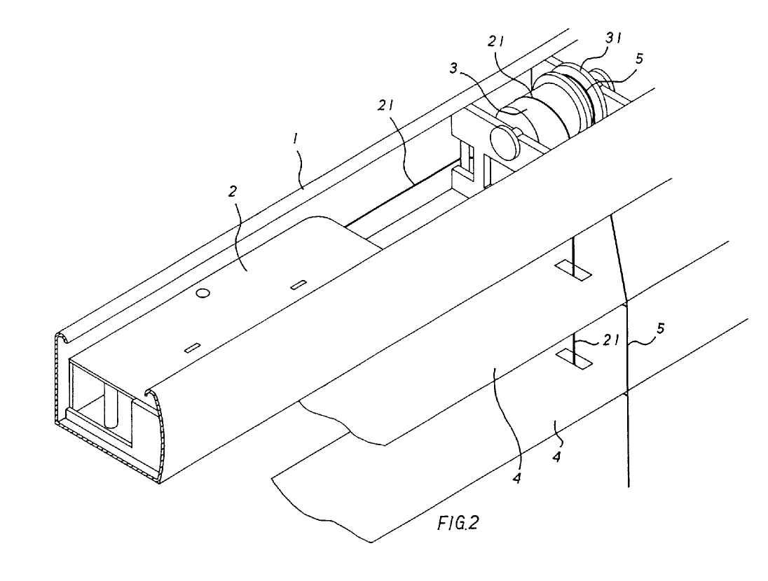

An adjustable structure of a curtain for adjusting the angle of curtain blade in accordance with the present invention comprises a winding tube 3 disposed in an upper rail 1 of a curtain 10, a pulling string 21 for controlling the rise and fall of the curtain winds around the winding tube 3 and is then passed through curtain blades 4 (as shown in FIGS. 1 and 2). One end of the winding tube 3 is disposed with a rubbing wheel 31 for hanging the top end of a suspending string 5 that is provided for insertion of the curtain blades 4. Thereby, during the rise and fall of the curtain blades 4, the suspending string 5 is pulled towards the rotating direction of the winding tube 3 firstly, so that the angle of the curtain blades 4 is adjusted.

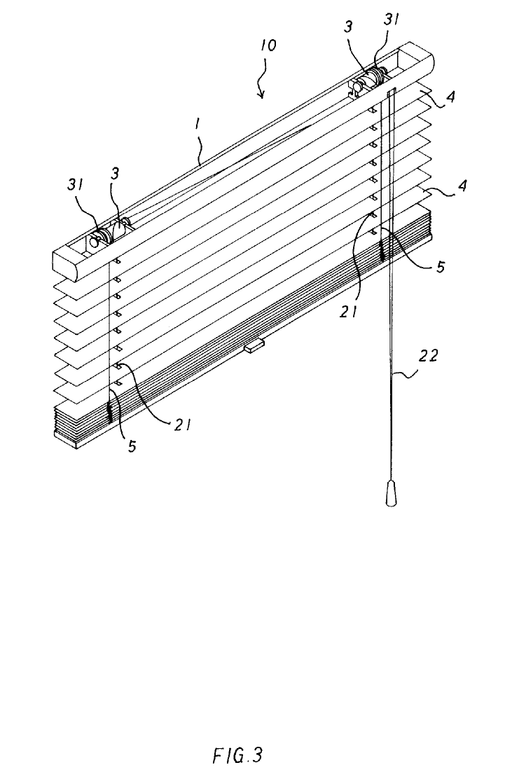

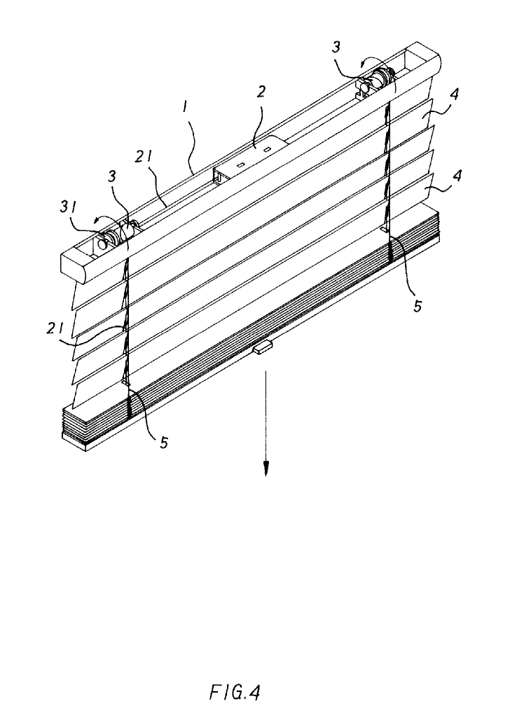

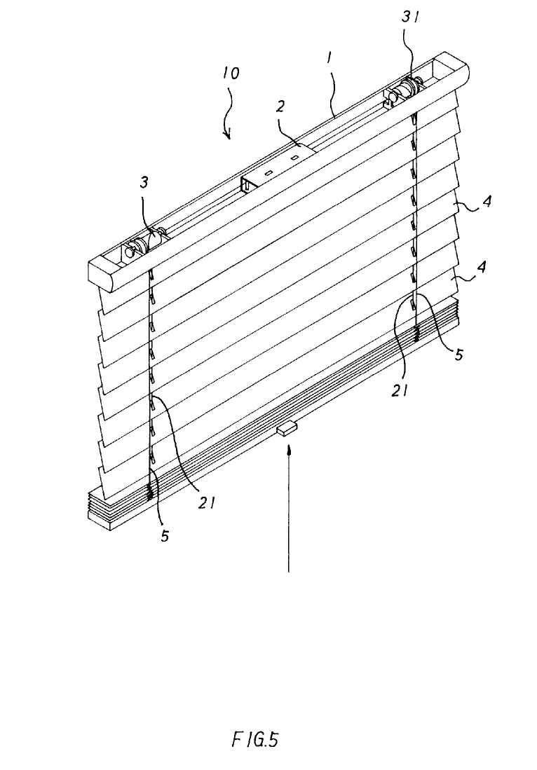

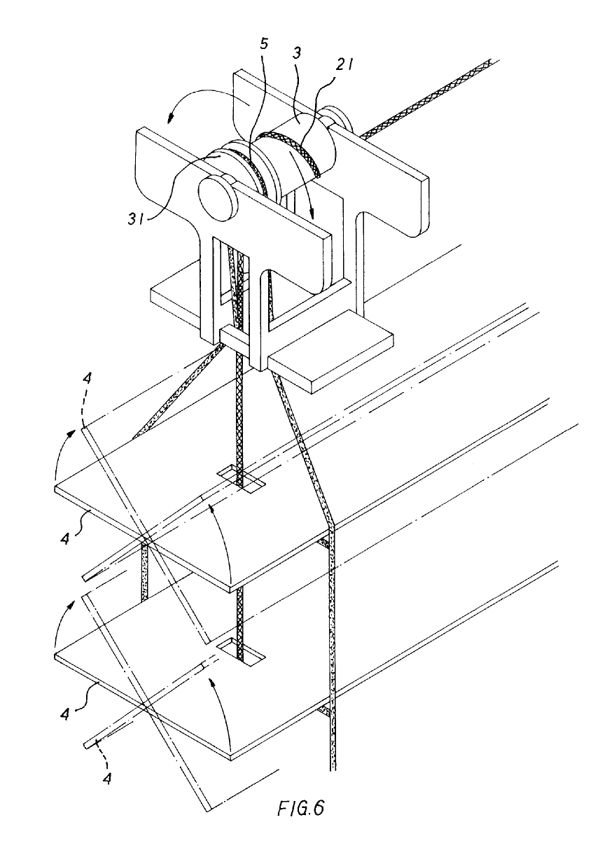

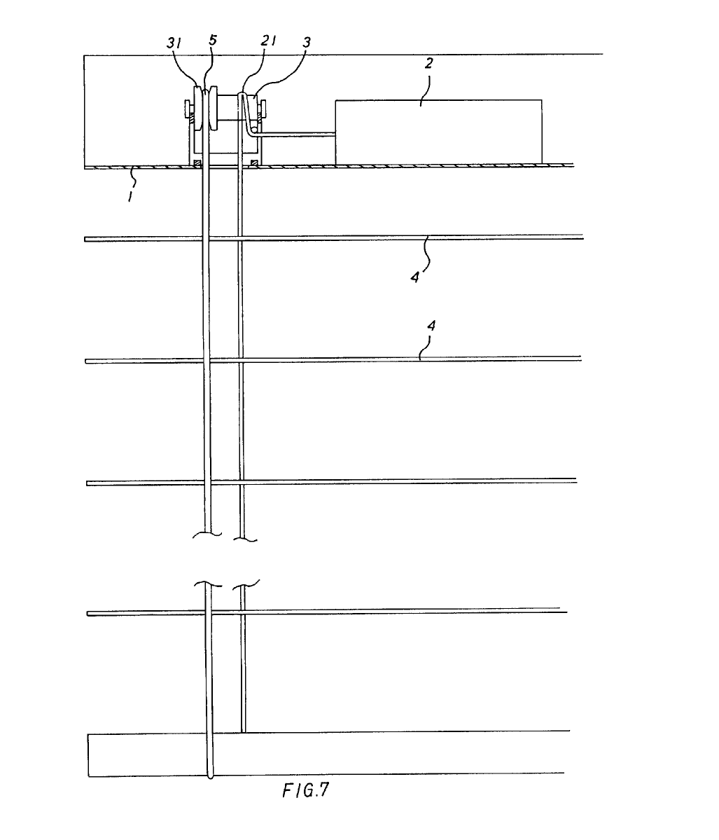

Since the winding tube 3 serves as a guiding wheel when the pulling string 21 pulls the curtain blades 4, the winding tube 3 will be rotated by pulling the pulling string 21 (the position of the pulling string 21 is controlled by a winder 2, or a manual string 22 as shown in FIG. 3). Since one end of the winding tube 3 is disposed with the rubbing wheel 31 (the rubbing wheel 31 rotates along with the winding tube 3), the suspending string 5 hanged on the rubbing wheel 31 will also be rotated along with the winding tube 3. However, there will appear a dead point after the angle of the curtain blades 4 connected beneath the suspending string 5 is adjusted to such an extent the curtain blades 4 are brought into contact with each other (as shown in FIGS. 4 and 5), the curtain blades 4 will be maintained in a skewed position during the rise and fall of the curtain. After the curtain blades 4 are adjusted to a predetermined position, and when the user slightly reverse the curtain blades 4, since the rotating direction of the rubbing wheel 31 is changed according to that of the winding tube 3, and the rotation angle of the suspending string 5 is adjusted by the rubbing wheel 31 (as shown in FIGS. 6 and 7, if the curtain blades 4 are skewed outward at the beginning, the curtain blades 4 can be rotated to the horizontal position and finally adjusted to an inwardly-skewed position), and thus the angle of the curtain blades 4 can be controlled easily. By such arrangement, the rise and fall motion and the angle-adjustment of the curtain blades 4 can be achieved simultaneously. Therefore, the curtain 10 is easy to operate, low cost, and has a nice appearance.

Since the rubbing wheel 31 rotates along with the winding tube 3, and not limited to being coaxial with the winding tube 3, and the size of the winding tube 3 and the rubbing wheel 31 can be different (in the present invention, the rubbing wheel 31 is a little bigger than the winding tube 3, thus obtaining a bigger friction between the suspending string 5 and the rubbing wheel 31). In addition, the direction of the rubbing wheel 31 can be reversed to that of the winding tube 3 (for example, the winding tube 3 and the rubbing wheel 31 is connected by a gear).

While we have shown and described various embodiments in accordance with the present invention, it should be clear to those skilled in the art that further embodiments may be made without departing from the scope of the present invention.

What is claimed is:

1. An adjustable structure of a curtain for adjusting the angle of curtain blade, comprising a winding tube disposed in an upper rail of a curtain, a pulling string for controlling the rise and fall of the curtain winds around the winding tube and then being passed through curtain blades, one end of the winding tube being disposed with a rubbing wheel for hanging the top end of a suspending string that is provided for insertion of the curtain blades, thereby during the rise and fall of the curtain blades, the suspending string being pulled towards the rotating direction of the winding tube firstly, so that the angle of the curtain blades being adjusted.

2. The adjustable structure of a curtain for adjusting the angle of curtain blade as claimed in claim 1, wherein the rise and fall of the pulling string is controlled by a roller.

3. The adjustable structure of a curtain for adjusting the angle of curtain blade as claimed in claim 1, wherein the rise and fall of the pulling string is by using a manual string.

4. The adjustable structure of a curtain for adjusting the angle of curtain blade as claimed in claim 1, wherein the rubbing wheel and the winding tube are disposed in the upper rail in the same axis.

5. The adjustable structure of a curtain for adjusting the angle of curtain blade as claimed in claim 1, wherein the rubbing wheel and the winding tube are disposed in the upper rail in different axis.

6. The adjustable structure of a curtain for adjusting the angle of curtain blade as claimed in claim 1, wherein the winding tube and the rubbing wheel have the same rotating path.

7. The adjustable structure of a curtain for adjusting the angle of curtain blade as claimed in claim 1, wherein the winding tube and the rubbing wheel have different rotating path.

8. The adjustable structure of a curtain for adjusting the angle of curtain blade as claimed in claim 1, wherein the winding tube and the rubbing wheel are rotated in the same direction.

9. The adjustable structure of a curtain for adjusting the angle of curtain blade as claimed in claim 1, wherein the winding tube and the rubbing wheel are rotated in different direction.

10. The adjustable structure of a curtain for adjusting the angle of curtain blade as claimed in claim 2, wherein the rubbing wheel and the winding tube are disposed in the upper rail in the same axis.

11. The adjustable structure of a curtain for adjusting the angle of curtain blade as claimed in claim 3, wherein the rubbing wheel and the winding tube are disposed in the upper rail in the same axis.

12. The adjustable structure of a curtain for adjusting the angle of curtain blade as claimed in claim 2, wherein the rubbing wheel and the winding tube are disposed in the upper rail in different axis.

13. The adjustable structure of a curtain for adjusting the angle of curtain blade as claimed in claim 3, wherein the rubbing wheel and the winding tube are disposed in the upper rail in different axis.

14. The adjustable structure of a curtain for adjusting the angle of curtain blade as claimed in claim 2, wherein the winding tube and the rubbing wheel have the same rotating path.

15. The adjustable structure of a curtain for adjusting the angle of curtain blade as claimed in claim 3, wherein the winding tube and the rubbing wheel have the same rotating path.

16. The adjustable structure of a curtain for adjusting the angle of curtain blade as claimed in claim 2, wherein the winding tube and the rubbing wheel have different rotating path.

17. The adjustable structure of a curtain for adjusting the angle of curtain blade as claimed in claim 3, wherein the winding tube and the rubbing wheel have different rotating path.

18. The adjustable structure of a curtain for adjusting the angle of curtain blade as claimed in claim 2, wherein the winding tube and the rubbing wheel are rotated in the same direction.

19. The adjustable structure of a curtain for adjusting the angle of curtain blade as claimed in claim 3, wherein the winding tube and the rubbing wheel are rotated in the same direction.

20. The adjustable structure of a curtain for adjusting the angle of curtain blade as claimed in claim 2, wherein the winding tube and the rubbing wheel are rotated in different direction.
